(19) United States
(12) Patent Application Publication
(10) Pub. No.: US 2011/0142456 A1
(43) Pub. Date: Jun. 16, 2011

(54) APPARATUS AND METHOD FOR DETECTING SIGNAL BEAM

(75) Inventors: Tsukasa TAKAHASHI, Kawasaki (JP); Toshihiro OHTANI, Kawasaki (JP)

(73) Assignee: FUJITSU LIMITED, Kawasaki-shi (JP)

(21) Appl. No.: 12/965,921

(22) Filed: Dec. 12, 2010

(30) Foreign Application Priority Data
Dec. 14, 2009 (JP) 2009-282898

(51) Int. Cl. H04B 10/00

(52) U.S. Cl. 398/152

(57) ABSTRACT

A signal-light detection apparatus includes a polarization extractor that extracts a polarization component that is substantially in parallel with a specified axial direction from an input light, a polarization rotator that changes a relative angle between a direction of polarization of the input light and an axial direction of the polarization extractor, a photodetector that detects an optical power of the polarization component extracted by the polarization extractor, and a determination device that determines whether the input light includes a signal component, based on a variation in the optical power detected by the photodetector.

### CROSS-REFERENCE TO RELATED APPLICATIONS

This application is based upon and claims the benefit of priority of the prior Japanese Patent Application No. 2009-282898, filed on Dec. 14, 2009, the entire contents of which are incorporated herein by reference.

### FIELD

The embodiments discussed herein are related to a signal-light detection apparatus and method for detecting the presence or absence of a signal component of a light input through, for example, an optical amplifier.

### BACKGROUND

For wavelength division multiplexing (WDM) transmission, with a transmission speed at or above 10 Gb/s, the effects of chromatic dispersion resulting from fiber transmission cause distortion to occur in the waveform of a signal and degrades reception characteristics of the signal light. To address this, for high-speed WDM optical fiber transmission, it is necessary to compensate for chromatic dispersion. Typically, chromatic dispersion is compensated for over the full range of wavelengths of a WDM light in a collective manner by the use of a dispersion compensating fiber (DCF). However, in the case of a WDM light that includes many channels (wavelengths), compensation for chromatic dispersion employing the DCF may be larger than necessary or insufficient, depending on the channel.

Remaining chromatic dispersion resulting from the above-described excess or deficiency of compensation for chromatic dispersion (hereinafter referred to as “residual dispersion”) can be at a level that does not virtually affect reception characteristics for, for example, a signal light of 10 Gb/s. However, in the case of a high-speed signal light at or above 40 Gb/s, the residual dispersion has unignorable effects on reception characteristics. Therefore, residual dispersion is compensated for by the provision of a tunable dispersion compensator to each channel of a WDM light.

FIG. 1 illustrates an example configuration of a reception section in a traditional WDM optical transmission system in a related art.

In FIG. 1, when a WDM light passing through an optical transmission line 501 reaches a reception end, the WDM light is collectively amplified by a WDM optical amplifier 502. After that, chromatic dispersion occurring in the signal light of each channel is collectively compensated for by a dispersion compensating fiber (DCF) 503. A WDM light output from the DCF 503 is demultiplexed into signal lights of channels by a demultiplexer 504, and they are transmitted to their respective optical receiver unit s 505.

Each of the optical receiver unit s 505 includes a single-wavelength optical amplifier 511, a tunable dispersion compensator (TDC) 512, an optical receiver (RX) 513, and a control circuit 514. The single-wavelength optical amplifier 511 amplifies a signal light obtained by the demultiplexer 504 to a necessary or desired level and outputs it to the TDC 512. The TDC 512 compensates for residual dispersion of the signal light output from the single-wavelength optical amplifier 511 and outputs the signal light to the optical receiver 513. The amount of dispersion compensation by the TDC 512 is variably controlled by the control circuit 514. The optical receiver 513 performs reception processing required for identifying and reproducing the signal light output from the TDC 512 and outputs information regarding a reception state of the signal light (hereinafter referred to as reception information) to the control circuit 514. The control circuit 514 performs feedback control for optimizing the amount of dispersion compensation by the TDC 512 on the basis of the reception information from the optical receiver 513. The single-wavelength optical amplifier may also be a WDM optical amplifier.

In the reception section of the above-described traditional WDM optical transmission system, an amplified spontaneous emission (ASE) light occurs in optical amplification at each of the WDM optical amplifier 502 and the single-wavelength optical amplifier 511 in the optical receiver unit 505. The amount of the ASE light occurring in the WDM optical amplifier 502 varies depending on the type of an optical fiber used in the optical transmission line 501, the transmission distance, and the number of operational wavelengths. If the WDM optical transmission system employs a multistage relay system in which an inline amplifier is arranged in the optical transmission line 501, an ASE light also occurs between relay sections, and the accumulated ASE light is provided to the WDM optical amplifier 502 in the reception section.

Typically, when the WDM optical amplifier 502 has no operational channel of an input WDM light, it is shut down. In this case, because no ASE light occurs in the WDM optical amplifier 502, no light is input into each of the optical receiver unit s 505. Accordingly, the optical receiver unit 505 can detect an interruption of a signal light by monitoring an input level. However, when there are one or more operational channels of a WDM light, the WDM optical amplifier 502 is activated and an ASE light occurs over the full amplified wavelength range. Therefore, an ASE light component within a transmission range that corresponds to each channel of the demultiplexer 504 is input to not only an optical receiver unit 505 corresponding to each of the operational channels but also another optical receiver unit 505 that does not correspond to the operational channel. The input of the ASE light to the optical receiver unit 505 that does not correspond to the operational channel causes a problem in which an interruption of a signal light cannot be detected if the level of the signal light in the optical transmission line 501 is small, for example.

Specifically, the single-wavelength optical amplifier 511 in the optical receiver unit 505 typically has the function of detecting the presence or absence of a signal component in response to an input optical level. The threshold used in that detection is set at a level smaller than the minimum reception level of a signal light by a specified value (e.g., 3 dB or 6 dB). That is, if the level of a light input to the single-wavelength optical amplifier 511 is lower than the threshold, an interruption of the signal light is detected; if it exceeds the threshold, the presence of the signal light is detected. When the interruption of the signal light is detected, in order to prevent an optical surge caused by the signal light returning thereafter, the single-wavelength optical amplifier 511 is deactivated and a loss of signal (LOS) alarm that indicates the interruption of the signal light is raised.

Under such circumstances where the function of detecting a signal light is activated, when the level of an ASE light input to the optical receiver unit 505 increases, even if it does not correspond to the operation channel, the level of the light input to the single-wavelength optical amplifier 511 exceeds the threshold, an interruption of the signal light cannot be detected. This disables the single-wavelength optical amplifier 511 from being shut down and a LOS alarm from being raised. If the single-wavelength optical amplifier 511 is not shut down, the optical receiver 513 may be broken by an optical surge, and needless power for operating the single-wavelength optical amplifier 511 is consumed.

One example of a traditional technique to avoid inaccurate detection of a signal light resulting from an ASE light is a technique of determining an input state of a signal light input to the optical receiver unit 505 on the basis of whether a clock signal in synchronization with the signal light has been detected in the optical receiver 513. Specifically, for an example configuration illustrated in FIG. 1, when reception information output from the optical receiver 513 includes clock-signal detection information and the clock-signal detection information notifies the control circuit 514 that no clock signal has been detected, the control circuit 514 detects an interruption of the signal light and raises a LOS alarm.

Another example traditional technique is extracting part of a light input to an optical receiver unit, separating it into four separated lights, extracting four polarization components having mutually different polarization parameters from the separated lights, and determining whether a signal light has been input on the basis of the polarization components (see, for example, Japanese Laid-open Patent Publication No. 2008-278082).

However, for the above-described traditional technique of detecting the presence or absence of a signal light on the basis of clock-signal detection information, an increase in residual dispersion in a signal light input to the optical receiver 513 will affect reproduction of a clock signal. To address this, it is necessary to check a detection state of the clock signal in the optical receiver 513 after feedback control for the TDC 512 converges to some extent. This results in a problem in which the time required for detecting the presence or absence of a signal light is long.

### SUMMARY

According to an aspect of the invention, a signal-light detection apparatus includes a polarization extractor that extracts a polarization component that is substantially in parallel with a specified axial direction from an input light, a polarization rotator that changes a relative angle between a direction of polarization of the input light and an axial direction of the polarization extractor, a photodetector that detects an optical power of the polarization component extracted by the polarization extractor, and a determination device that determines whether the input light includes a signal component, based on a variation in the optical power detected by the photodetector.

The object and advantages of the invention will be realized and attained by at least the features, elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example configuration of a reception section in a traditional WDM optical system in a related art.

FIG. 2 illustrates an example configuration of an optical receiver unit in which a signal-light detection apparatus according to a first embodiment is used.

FIG. 3 illustrates a schematic configuration of a terminal apparatus that includes a plurality of transponders each employing the optical receiver unit illustrated in FIG. 2.

FIG. 4 illustrates an example of a WDM optical transmission system established using the terminal apparatuses illustrated in FIG. 3.

FIGS. 5A and 5B illustrate a relationship between the direction of polarization of a monitored light and the direction of a transmission axis of a polarization extractor according to the first embodiment.

FIG. 6 illustrates an example of comparison between a relationship between a detected optical power and an angle of rotation in the direction of polarization for a signal light and that for an ASE light according to the first embodiment.

FIGS. 7A and 7B illustrate example configurations of a measurement system for measuring a variation in the level of an output signal of a photodetector.

FIG. 8A illustrates a waveform of an output signal of the photodetector measured by the measurement system illustrated in FIG. 7A when only a signal light is included.

FIG. 8B illustrates a waveform of an output signal of the photodetector measured by the measurement system illustrated in FIG. 7A when only an ASE light is included.

FIG. 9A illustrates a waveform of an output signal of the photodetector measured by the measurement system illustrated in FIG. 7B when both a signal light and an ASE light are included.

FIG. 9B illustrates results of measurement of a spectrum of a light output from an optical amplifier.

FIG. 10 illustrates an example configuration of an optical receiver unit in which a signal-light detection apparatus according to a second embodiment is used.

FIG. 11 illustrates a relationship between the direction of polarization of a monitored light and the direction of a transmission axis of a polarization extractor according to the second embodiment.

FIG. 12 illustrates an example configuration in which the signal-light detection apparatus is disposed before an optical amplifier in the optical receiver unit.

FIG. 13 illustrates an example configuration in which the signal-light detection apparatus is disposed after a TDC in the optical receiver unit.

FIG. 14A illustrates a case where a transmission axis of a polarizer and the direction of polarization of a signal component are coincident.

FIG. 14B illustrates a case where the transmission axis of the polarizer is inclined approximately 45° toward signal components.

FIG. 14C illustrates a case where the transmission axis of the polarizer and the direction of polarization of a signal component are coincident.

FIG. 14D illustrates a case where, for a signal component oscillating in a substantially vertical direction, the power of a transmitted light is largest when the angle of rotation of the polarizer is approximately 0° and 180°.

FIG. 15 illustrates one example of a WDM optical transmission system that includes a polarization scrambler inserted at a transmission side of a transponder.

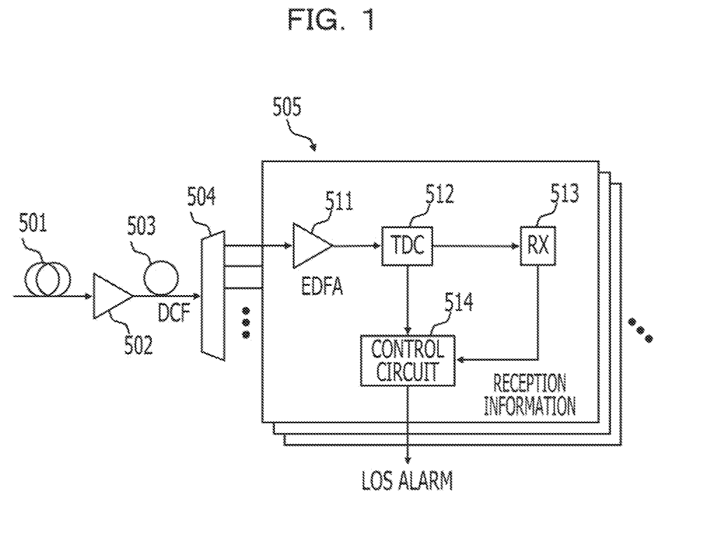

### DESCRIPTION OF EMBODIMENTS

Embodiments are described in detail with reference to the accompanying drawings.

For above-described traditional technique of detecting the presence or absence of a signal light on the basis of four polarization components having mutually different polarization parameters, a complex optical system for extracting the polarization components is required, and processing for electric signals obtained by photoelectric conversion on the polarization components, specifically, arithmetic processing for calculating the degree of polarization (DOP) is also complicated.

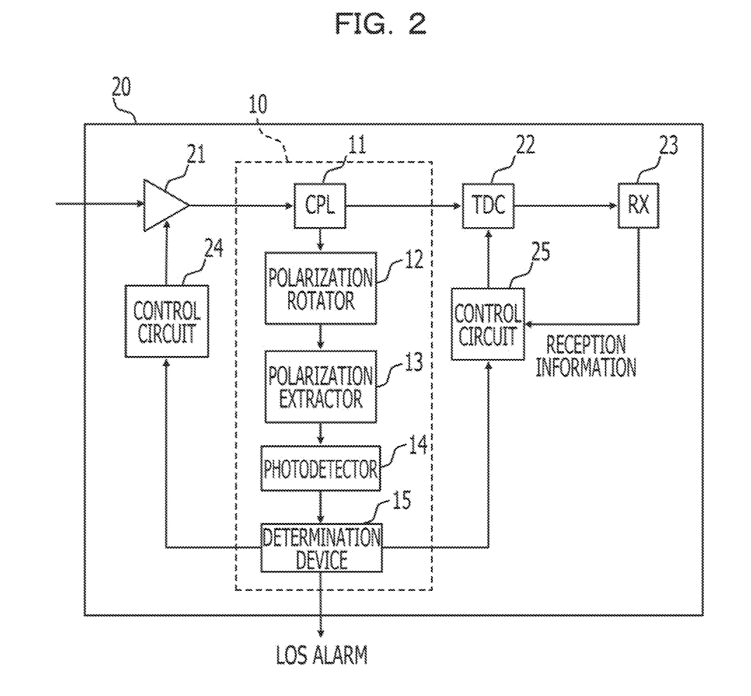

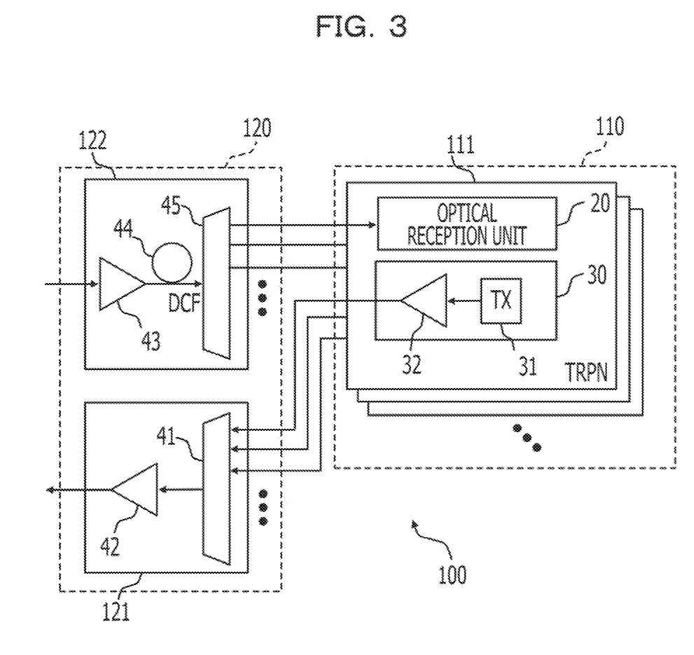

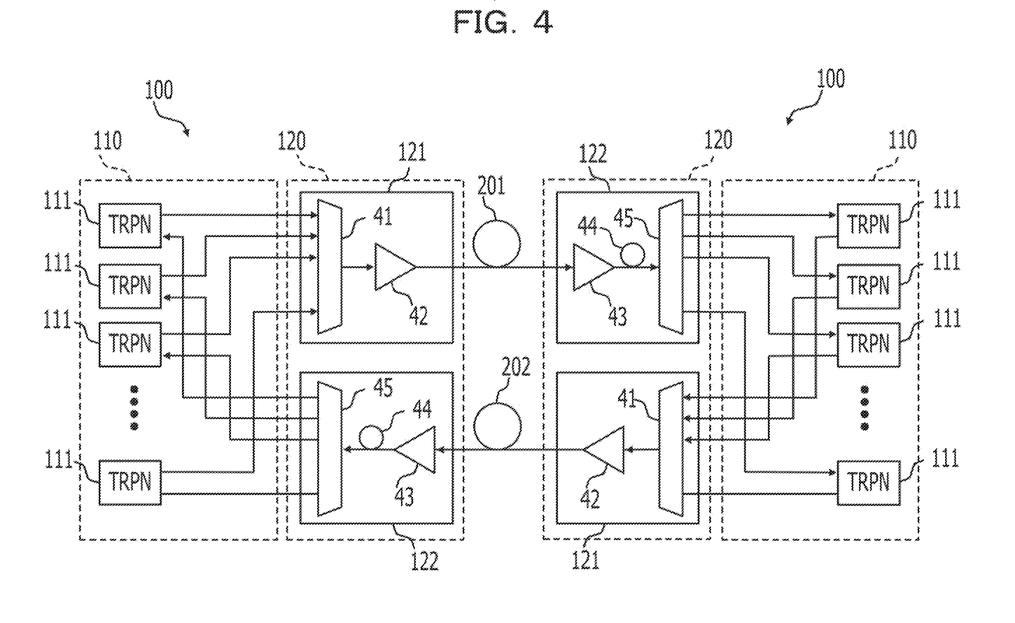

FIG. 2 illustrates an example configuration of an optical receiver unit in which a signal-light detection apparatus according to a first embodiment is used. FIG. 3 illustrates a schematic configuration of a terminal apparatus that includes a plurality of transponders each employing the optical receiver unit illustrated in FIG. 2. FIG. 4 illustrates an example of a WDM optical transmission system established using the terminal apparatuses illustrated in FIG. 3.

Referring to FIG. 2, a signal-light detection apparatus 10 according to the first embodiment may include a splitter (CPL: coupler) 11 disposed between a single-wavelength optical amplifier 21 and a tunable dispersion compensator (TDC) 22 in an optical receiver unit 20, a polarization rotator 12 connected to a division port of the splitter 11, a polarization extractor 13 for receiving a light output from the polarization rotator 12, a photodetector 14 for receiving a light that has passed through the polarization extractor 13, and a determination device 15 for determining the presence or absence of a signal light on the basis of detection performed by the photodetector 14, for example. The optical receiver unit 20, which employs the signal-light detection apparatus 10, includes an optical receiver (RX) 23 for identifying and reproducing an output light output from the TDC 22, a control circuit 24 for controlling an operation of the single-wavelength optical amplifier 21, and a control circuit 25 for controlling the amount of dispersion compensation by the TDC 22, in addition to the above-described single-wavelength optical amplifier 21 and TDC 22.

The splitter 11 branches part of a light that has been output from the single-wavelength optical amplifier 21 and then will be sent to the TDC 22 as a monitored light and outputs the monitored light to the polarization rotator 12.

The polarization rotator 12 rotates the direction of polarization (oscillation) of the monitored light obtained by the splitter 11 in an angle range at or above approximately 90°. Examples of the polarization rotator 12 may include a Faraday rotator, liquid crystal, a polarization scrambler, a polarization modulator, a wave plate, a birefringent plate, and a polarization-maintaining fiber. Examples of a method for rotating the direction of polarization (rotation pattern) may include approximately 360° continuous rotation in a single direction and continuous reciprocation of the angle of rotation between approximately 0° and 90° or between approximately 0° and 180°. The rotation speed may be set at any value in consideration of a response speed of the photodetector 14; specifically, it may preferably be set in the range from several hundred kilohertz to several megahertz.

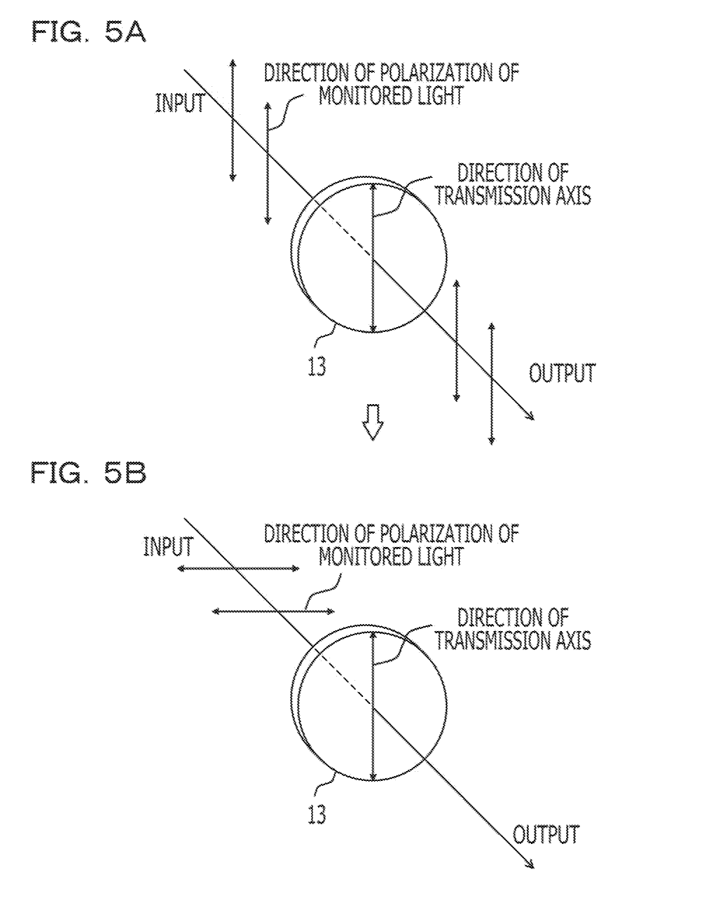

The polarization extractor 13 extracts a polarization component in a certain direction from a monitored light output from the polarization rotator 12 and provides it to the photodetector 14. Examples of the polarization extractor 13 may include a polarizer and a polarization splitter. Here, the polarization extractor 13 is used in a fixed state where its transmission axis is in a specified direction. As illustrated in FIG. 5A, when the direction of polarization of a monitored light input to the polarization extractor 13 is substantially in parallel with the direction of the transmission axis of the polarization extractor 13, the polarization component of the monitored light extracted by the polarization extractor 13 has the maximum power. In contrast, as illustrated in FIG. 5B, when the direction of polarization of a monitored light input to the polarization extractor 13 is substantially orthogonal to the direction of the transmission axis of the polarization extractor 13, the polarization component of the monitored light extracted by the polarization extractor 13 is absent.

The photodetector 14 converts a polarization component of a monitored light extracted by the polarization extractor 13 into an electric signal and outputs it to the determination device 15. The electric signal changes its level in accordance with the power of the polarization component input to the photodetector 14. That is, the photodetector 14 detects the power of the polarization component of the monitored light extracted by the polarization extractor 13.

The determination device 15 monitors the level of an electric signal output from the photodetector 14, determines the presence of a signal light when it detects a variation in the level within a specified measurement time, and determines an interruption of a signal light when it does not detect a variation in the level. The determination device 15 raises a LOS alarm when determining the interruption of the signal light. The determination device 15 outputs a signal that indicates determination of the presence or absence of the signal light to the control circuit 24 for the single-wavelength optical amplifier 21 and the control circuit 25 for the TDC 22.

The single-wavelength optical amplifier 21 amplifies a light input to the optical receiver unit 20 to a desired level and outputs the amplified light to the TDC 22 through the splitter 11. This optical amplification operation of the single-wavelength optical amplifier 21 is controlled in response to a signal output from the control circuit 24.

The TDC 22 compensates for residual dispersion of a signal light included in a light sent from the single-wavelength optical amplifier 21 through the splitter 11 and outputs the light to the optical receiver 23. The amount of dispersion compensation by the TDC 22 is variably controlled in response to a signal output from the control circuit 25.

The optical receiver 23 performs reception processing required for identifying and reproducing a light output from the TDC 22. The optical receiver 23 outputs information regarding a reception state of a signal light (e.g., a bit error rate or the number of corrected errors in forward error correction (FEC)) to the control circuit 25.

The control circuit 24 controls a driven state of the single-wavelength optical amplifier 21 on the basis of monitoring by an output monitor of the single-wavelength optical amplifier 21 such that an output optical power of the single-wavelength optical amplifier 21 is substantially constant at a desired level. The control circuit 24 shuts down the single-wavelength optical amplifier 21 when receiving a signal that indicates an interruption of a signal light from the determination device 15 of the signal-light detection apparatus 10. When receiving a signal that indicates the presence of a signal light from the determination device 15, the control circuit 24 cancels the shutdown of the single-wavelength optical amplifier 21.

The control circuit 25 generates a control signal for achieving the desired amount of dispersion compensation by the TDC 22 on the basis of reception information from the optical receiver 23 and outputs the control signal to the TDC 22. This feedback control for the amount of dispersion compensation by the TDC 22 performed by the control circuit 25 is suspended when the control circuit 25 receives a signal that indicates an interruption of a signal light from the determination device 15 of the signal-light detection apparatus 10 and is executed when the control circuit 25 receives a signal that indicates the presence of a signal light from the determination device 15.

Here, a case where, in response to determination by the signal-light detection apparatus 10, the control circuit 24 performs shutdown control for the single-wavelength optical amplifier 21 and the control circuit 25 switches (between suspension and execution of) feedback control for the TDC 22 is described. However, either one of the shutdown controls for the single-wavelength optical amplifier 21 and the switching of the feedback control for the TDC 22 may be performed in response to determination by the signal-light detection apparatus 10.

The above-described optical receiver unit 20 employing the signal-light detection apparatus 10 may be used in a reception section of each of a plurality of transponders (TRPNs) 111 included in a terminal apparatus 100 illustrated in FIG. 3, for example.

Each of the transponders 111 includes an optical transmission unit 30 including an optical transmitter (TX) 31 and a single-wavelength optical amplifier 32, in addition to the optical receiver unit 20.

The optical transmitter 31 generates a signal light having a wavelength corresponding to a reception channel for the optical receiver unit 20.

The single-wavelength optical amplifier 32 amplifies a signal light output from the optical transmitter 31 to a desired level. When an output optical power of the optical transmitter 31 is at a sufficient level, the single-wavelength optical amplifier 32 may be omitted.

The terminal apparatus 100 includes a transponder section 110 including a plurality of transponders 111 and a WDM section 120 for multiplexing and demultiplexing signal lights of different channels (wavelengths) transmitted and received by each of the transponders 111. The WDM section 120 includes a multiplexing unit 121 and a demultiplexing unit 122.

The multiplexing unit 121 multiplexes signal lights having mutually different wavelengths output from the transponders 111 using a multiplexer 41 to generate a WDM light, collectively amplifies the WDM light using a WDM optical amplifier 42, and outputs it. The WDM light output from the multiplexing unit 121 is transmitted to an optical transmission line connected to the terminal apparatus 100.

The demultiplexing unit 122 collectively amplifies a WDM light passing through the optical transmission line using a WDM optical amplifier 43, supplies the WDM light to a dispersion compensation fiber (DCF) 44, and collectively compensates for chromatic dispersion occurring in the signal light of each channel. The demultiplexing unit 122 demultiplexes the WDM light output from the DCF 44 in channels using a demultiplexer 45 and outputs the signal lights to the respective optical receiver unit s 20 of the corresponding transponders 111.

A WDM optical transmission system, for example, illustrated in FIG. 4, may be established using the above-described terminal apparatuses 100. In this WDM optical transmission system, the two terminal apparatuses 100 are interactively connected with a pair of optical transmission lines 201 and 202 disposed therebetween. A WDM light transmitted and received between the terminal apparatuses 100 may be relayed in a multistage manner employing in-line amplifiers arranged on the optical transmission lines 201 and 202.

Next, an operation of the signal-light detection apparatus 10 according to the first embodiment is described.

A light input to the optical receiver unit 20 using the signal-light detection apparatus 10 is one of the lights demultiplexed in channels by the demultiplexer 45 in the demultiplexing unit 122 of the terminal apparatus 100 (FIG. 3). When one or more channels of a WDM light input to the demultiplexing unit 122 are operated, the input light includes part of an ASE light occurring in the WDM optical amplifier 43 in the demultiplexing unit 122 (a component that passed through the demultiplexer 45). Therefore, the light input to the optical receiver unit 20 includes a signal light and an ASE light when its wavelength corresponds to an operation channel and includes only an ASE light when its wavelength does not correspond to the operational channel.

A light input to the optical receiver unit 20 further includes an additional ASE light by being amplified by the single-wavelength optical amplifier 21. This ASE light added in the amplification by the single-wavelength optical amplifier 21 is not filtered by the demultiplexer 45, unlike the ASE light occurring in the WDM optical amplifier 43, and therefore, it extends in a wide band corresponding to the amplification wavelength range of the single-wavelength optical amplifier 21. Each of the ASE light occurring in the WDM optical amplifier 43 and that in the single-wavelength optical amplifier 21 has a randomly polarized state. In contrast, a signal light passing through the optical transmission line has a substantially elliptically polarized state close to a linearly polarized state. The signal-light detection apparatus 10 utilizes a difference between the polarization state of the ASE light and that of the signal light and detects the presence or absence of a signal component in a light input to the optical receiver unit 20 through a procedure described below.

In the signal-light detection apparatus 10, the splitter 11 extracts part of a light output from the single-wavelength optical amplifier 21 as a monitored light and supplies the monitored light to the polarization rotator 12. The polarization rotator 12 rotates the direction of polarization of the monitored light in an angle range at or above approximately 90° and supplies it to the polarization extractor 13. The polarization extractor 13 extracts only a polarization component in a certain direction from the supplied monitored light. The polarization component extracted by the polarization extractor 13 is converted into an electric signal by the photodetector 14, and the signal is output to the determination device 15.

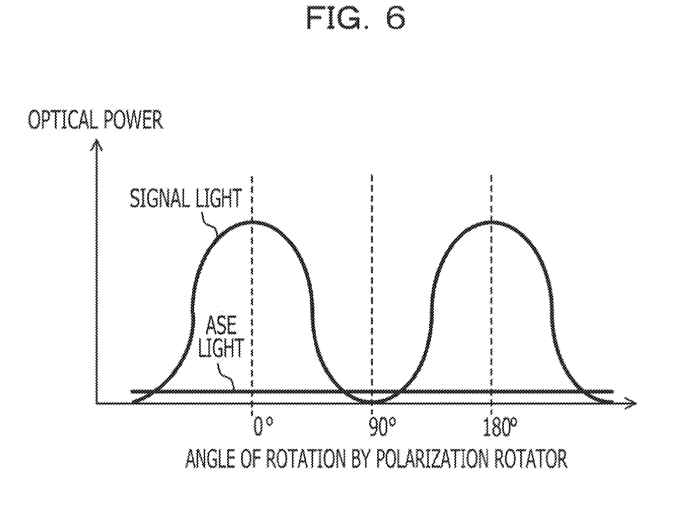

FIG. 6 illustrates an example of comparison between a relationship between an optical power detected by the photodetector 14 and an angle of rotation in the direction of polarization in the polarization rotator 12 for a signal light and that for an ASE light.

When a light input to the optical receiver unit 20 contains a signal light, if the direction of polarization of a signal-light component output from the polarization rotator 12 and the direction of the transmission axis of the polarization extractor 13 are substantially in parallel with each other, the optical power detected by the photodetector 14 is largest. The angle of rotation in the direction of polarization by the polarization rotator 12 in this case is indicated as 0° and 180° in FIG. 6. If the direction of polarization of a signal-light component output from the polarization rotator 12 and the direction of the transmission axis of the polarization extractor 13 are substantially orthogonal to each other, the optical power detected by the photodetector 14 is smallest. That is, when a light input to the optical receiver unit 20 contains a signal light, the optical power detected by the photodetector 14 is significantly changed by rotation of the direction of polarization by the polarization rotator 12 in an angle range at or above approximately 90°.

In contrast, when a light input to the optical receiver unit 20 does not include a signal light and includes only an ASE light, even if the randomly polarized ASE light is supplied to the polarization rotator 12, the ASE light output from the polarization rotator 12 is still a randomly polarized light. Therefore, of the ASE light supplied to the polarization extractor 13, only a slight component that is substantially in parallel with the direction of the transmission axis of the polarization extractor 13 is extracted by the polarization extractor 13. Accordingly, the optical power detected by the photodetector 14 does not depend on the angle of rotation by the polarization rotator 12 and is substantially constant at a low level.

The determination device 15 detects whether a substantial variation in the level has occurred in a signal output from the photodetector 14 within a specified measurement time on the basis of the above-described difference of characteristics between a signal light and an ASE light. The measurement time is set in consideration of a possibility that the polarization state of a signal light may be accidentally changed by, for example, application of a stress to the optical transmission line through which the signal light is conveyed. That is, a situation in which the accidental change of the polarization state cancels out a change in the direction of polarization caused by rotation by the polarization rotator 12 may occur, although such a situation is unlikely. Therefore, it may be preferable that a certain measurement time be prepared within a range that does not affect shutdown control for the optical amplifier to enable detection of a variation in the level resulting from rotation in the direction of polarization by the polarization rotator 12 even if the above-described situation occurs.

When detecting a variation in the level of a signal output from the photodetector 14, the determination device 15 determines that the light input to the optical receiver unit 20 includes a signal light. In contrast, when detecting no variation in the level of the signal output from the photodetector 14, the determination device 15 determines that the light input to the optical receiver unit 20 includes only an ASE light and a signal light is interrupted. When determining the interruption of the signal light, the determination device 15 raises a LOS alarm. Here, substantially in simultaneity with the raising of the LOS alarm, a signal indicating the interruption of the signal light is output from the determination device 15 to each of the control circuits 24 and 25. In response to this, the control circuit 24 performs shutdown control for the single-wavelength optical amplifier 21 and the control circuit 25 stops feedback control for the amount of dispersion compensation by the TDC 22. When a signal indicating the presence of a signal light is sent from the determination device 15 to each of the control circuits 24 and 25, the shutdown of the single-wavelength optical amplifier 21 is cancelled and the feedback control for the amount of dispersion compensation by the TDC 22 is executed.

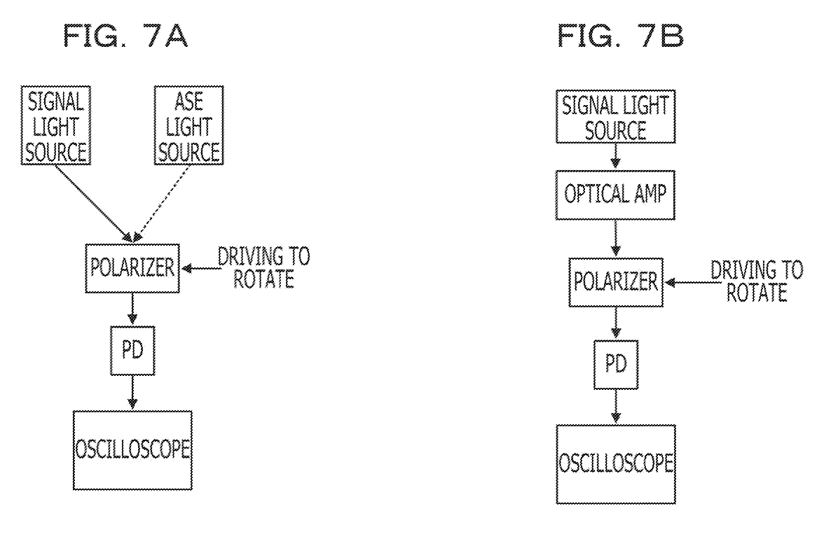

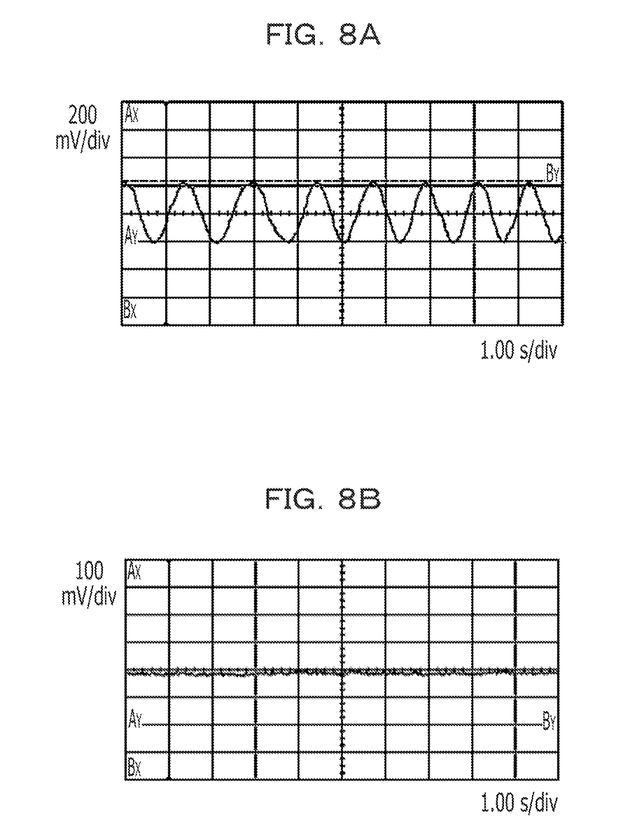

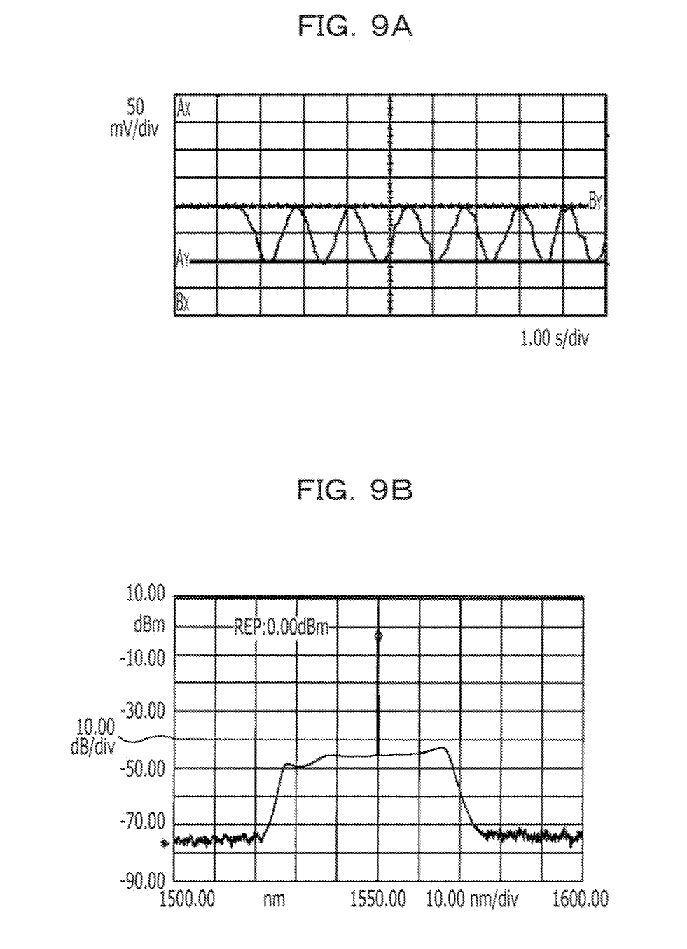

Results of observation of how the level of a signal output from the photodetector 14 varies using a measurement system An illustrated in FIG. 7A and a measurement system B illustrated in FIG. 7B are illustrated in FIGS. 8A, 8B, 9A, and 9B.

The measurement system A in FIG. 7A independently employs a signal light source and an ASE light source and measures a waveform of a signal output from a photodetector (PD) employing an oscilloscope when only a signal light is included and when only an ASE light is included The measurement system B in FIG. 7B amplifies a signal light generated by the signal light source employing an optical amplifier and measures a waveform of a signal output from a photodetector (PD) employing an oscilloscope when both a signal light and an ASE light are included Each of the measurement systems A and B achieves the function of both the polarization rotator 12 and the polarization extractor 13 illustrated in FIG. 2 by driving the polarizer to rotate and continuously rotating the direction of the transmission axis. The details of a configuration of driving the polarizer to rotate are described below.

FIG. 8A illustrates a waveform of a signal output from the photodetector measured employing the measurement system A using the oscilloscope when only a signal light is included. The waveform reveals that the level of the signal output from the photodetector periodically varies with time. FIG. 8B illustrates a waveform of a signal output from the photodetector measured employing the measurement system A using the oscilloscope when only an ASE light is included. The waveform reveals that the level of the signal output from the photodetector is substantially constant over time, in contrast to the case where only a signal light is included.

FIG. 9A illustrates a waveform of a signal output from the photodetector measured employing the measurement system B using the oscilloscope when both a signal light and an ASE light are included. FIG. 9B illustrates results of a spectrum of a light output from the optical amplifier. In this case, together with a single-wavelength signal light, a wide-band ASE light is supplied to the rotating polarizer. The waveform in FIG. 9A reveals that the level of the signal output from the photodetector periodically varies with time, as in the case where only a signal light is included illustrated in FIG. 8A.

With the above-described signal-light detection apparatus 10, whether a light input to the optical receiver unit 20 includes a signal light may be detected in a short time employing a simple optical system and simple detection of a variation in the level of an electric signal without being affected by an ASE light and, if an interruption of a signal light is determined, a LOS alarm may be reliably raised. The shutdown control for the single-wavelength optical amplifier 21 in the optical receiver unit 20 in response to the determination of the presence or absence of a signal light by the signal-light detection apparatus 10 may prevent or substantially attenuate an optical surge and reduce power consumption in the single-wavelength optical amplifier 21. Suspending feedback control for the TDC 22 when an interruption of a signal light is determined may avoid needless feedback control based on an ASE light, thus enabling a reduction in power consumption in the TDC 22. If the TDC 22 is a device that has a mechanical driving element (e.g., VIPA), its part life may also be extended.

Next, a signal-light detection apparatus according to a second embodiment is described.

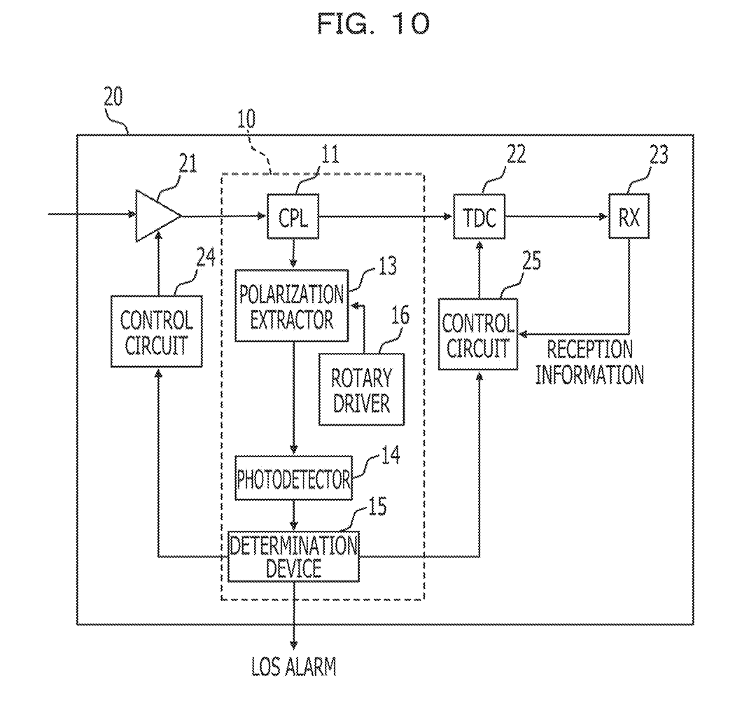

FIG. 10 illustrates an example configuration of an optical receiver unit in which the signal-light detection apparatus according to the second embodiment is used. In FIG. 10, the same reference numerals as in the above-described first embodiment indicate the same or corresponding portions. The same applies to other drawings.

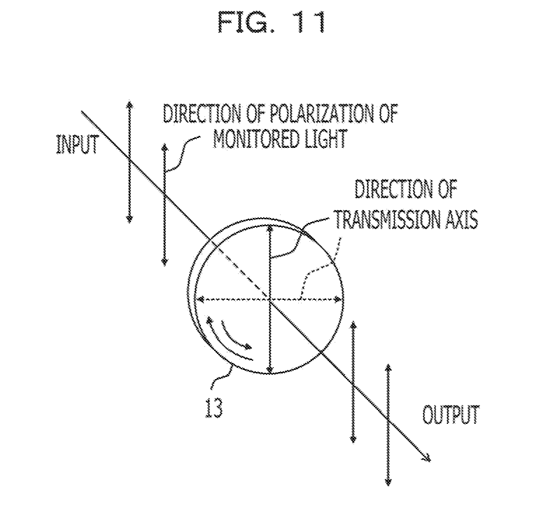

Referring to FIG. 10, the signal-light detection apparatus 10 according to the present embodiment includes, in place of the polarization rotator 12 at the first embodiment, a rotary driver 16 for rotating the polarization extractor 13. As illustrated in FIG. 11, for example, the rotary driver 16 rotates the polarizer itself used as the polarization extractor 13 in an angle range at or above approximately 90°. Such a configuration corresponds to the measurement systems A and B illustrated in FIGS. 7A and 7B, which are described above. The method for rotating the polarizer (rotation pattern) and the rotation speed are substantially the same as in the above-described case where the direction of polarization is rotated by the polarization rotator 12.

For the signal-light detection apparatus 10 having the above-described configuration, a monitored light obtained by the splitter 11 is directly supplied to the polarization extractor 13 rotated by the rotary driver 16. When the monitored light includes a signal light, as illustrated in FIG. 11, if the transmission axis of the rotating polarization extractor 13 is substantially in parallel with the direction of polarization of the monitored light, the optical power detected by the photodetector 14 is largest (corresponding to the above-described state at approximately 0° and 180° illustrated in FIG. 6). If the transmission axis of the rotating polarization extractor 13 is substantially orthogonal to the direction of polarization of the monitored light, the optical power detected by the photodetector 14 is smallest (corresponding to the above-described state at approximately 90° illustrated in FIG. 6). In contrast, when the monitored light does not include a signal light and includes only an ASE light occurring in the single-wavelength optical amplifier 21 and the like, because the ASE light is a randomly polarized light, even if the direction of the transmission axis is changed by rotation of the polarization extractor 13, the optical power detected by the photodetector 14 is substantially constant at a low level.

Accordingly, as in the case of the above-described first embodiment, the determination device 15 determines the presence of a signal light when detecting a variation in the level of a signal output from the photodetector 14 and determines an interruption of a signal light when detecting no variation in the level. When the interruption of the signal light is determined, the determination device 15 raises a LOS alarm. In response to the determination by the determination device 15, the control circuit 24 performs shutdown control for the single-wavelength optical amplifier 21 and the control circuit 25 switches (between suspension and execution of) feedback control for the TDC 22.

As described above, with the signal-light detection apparatus 10 according to the second embodiment, substantially the same advantages as in the above-described first embodiment are obtainable even by changing the direction of the transmission axis by rotating the polarization extractor 13 itself using the polarizer employing the rotary driver 16.

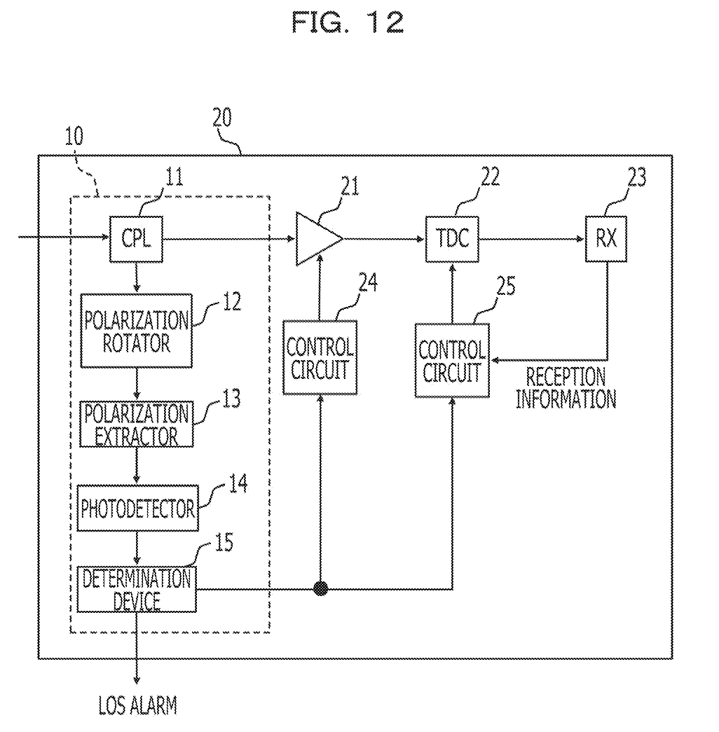

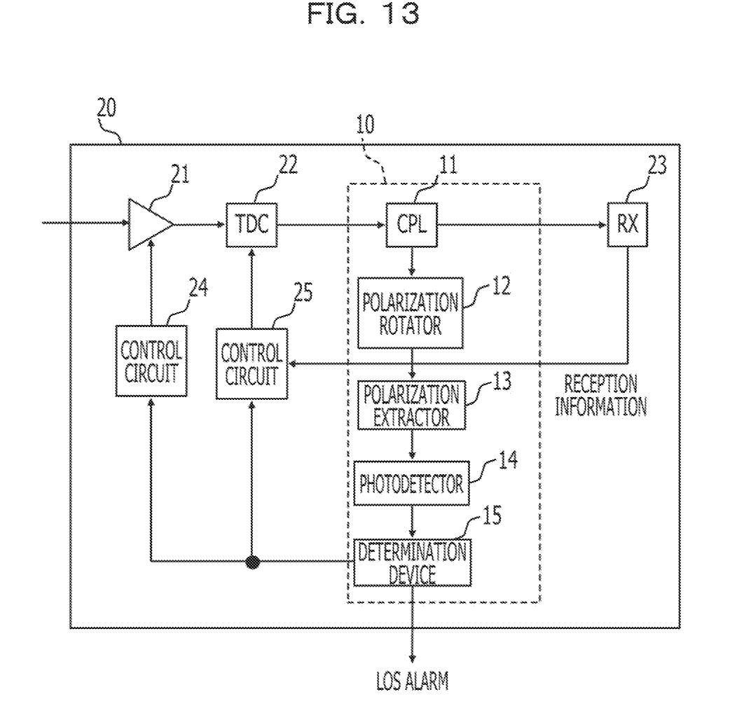

For the above-described first and second embodiments, an example in which the signal-light detection apparatus 10 is arranged between the single-wavelength optical amplifier 21 and the TDC 22 in the optical receiver unit 20 is described. However, the arrangement of the signal-light detection apparatus 10 in the optical receiver unit 20 is not limited to the described example. For example, the signal-light detection apparatus 10 may be arranged before the single-wavelength optical amplifier 21, as illustrated in FIG. 12, or alternatively, the signal-light detection apparatus 10 may be arranged between the TDC 22 and the optical receiver 23, as illustrated in FIG. 13.

When the signal-light detection apparatus 10 is arranged after the TDC 22, a monitored light obtained by the splitter 11 has an optical spectrum corresponding to a transmission wavelength characteristic of the TDC 22. For example, when a VIPA is used as the TDC 22, because its transmission wavelength characteristic periodically varies, after a wide-band ASE light occurring in the single-wavelength optical amplifier 21 is filtered by the TDC 22, the ASE light is extracted as a monitored light by the splitter 11. In this case, because the power of the ASE light included in the monitored light is significantly reduced, the presence or absence of a signal light may be determined using a typical threshold for an input optical power. In contrast, when the TDC 22 has a nonperiodic transmission wavelength characteristic, most of a wide-band ASE light occurring in the single-wavelength optical amplifier 21 passes through the TDC 22 and is extracted as a monitored light by the splitter 11. In this case, with a typical threshold for an input optical power in determination, there is a strong possibility that the presence or absence of a signal light may be incorrectly determined on the basis of the power of an ASE light. In consideration of this respect, for determination of the presence or absence of a signal light after the TDC having a nonperiodic transmission wavelength characteristic, the use of the signal-light detection apparatus 10 according to the above-described embodiments is particularly effective.

For the above-described first and second embodiments, an example in which a single-wavelength signal light input to the optical receiver unit 20 has a substantially elliptically polarized state close to a linearly polarized state is described. For example, even in a case where a signal light subjected to polarization multiplexing is input to the optical receiver unit 20, the presence or absence of the signal light may also be detected using a signal-light detection apparatus having basically the same configuration as in the above-described embodiments.

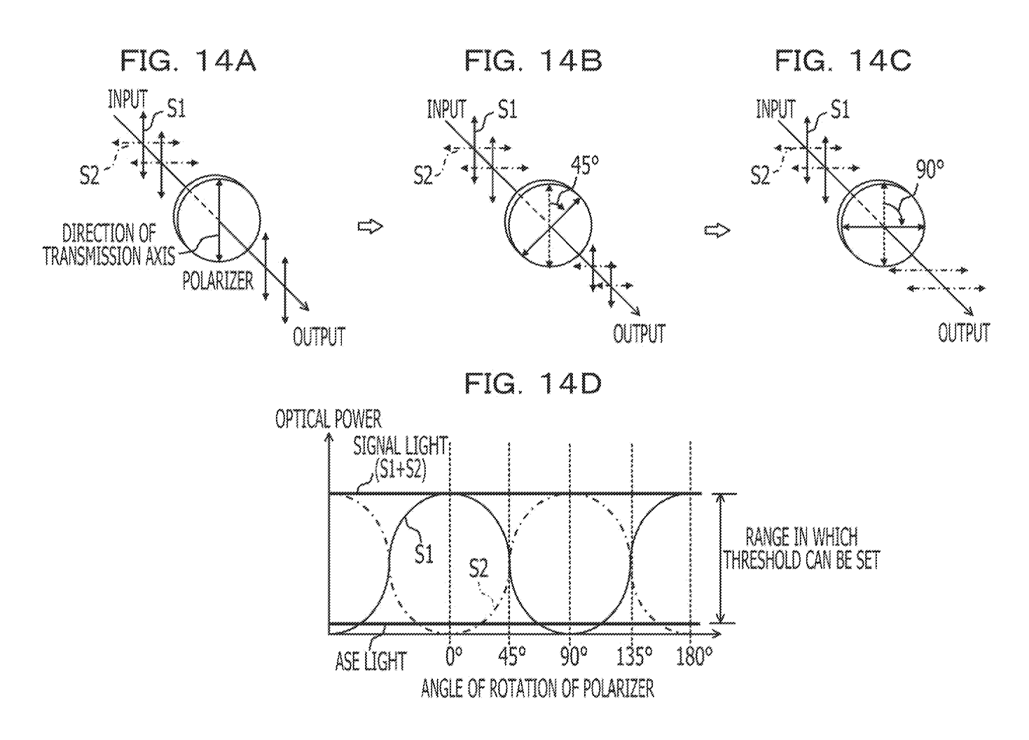

Specifically, signal light components S1 and S2 in which two lights having substantially orthogonal directions of polarization are polarization-multiplexed are described. FIG. 14A illustrates a case where the transmission axis of the polarizer and the direction of polarization of the signal light component S1 are coincident. FIG. 14B illustrates a case where the transmission axis of the polarizer is inclined approximately 45° toward the signal light components S1 and S2. FIG. 14C illustrates a case where the transmission axis of the polarizer and the direction of polarization of the signal light component S2 are coincident. As illustrated in FIG. 14D, for the signal light component S1 oscillating in a substantially vertical direction, the power of a transmitted light is largest when the angle of rotation of the polarizer is approximately 0° and 180°. For the signal light component S2 oscillating in a substantially horizontal direction, the power of a transmitted light is largest when the angle of rotation of the polarizer is approximately 90°. When a combination of the two signal components S1 and S2 is discussed on the basis of the above-described characteristics, if the signal components have substantially the same power, the optical power detected by the photodetector 14 is substantially constant regardless of the angle of rotation of the polarizer. However, if the signal components have different powers due to a polarization dependent loss (PDL) in the optical transmission line or the like, the optical power detected by the photodetector 14 varies in accordance with the angle of rotation of the polarizer. In either case, the mean level of the optical power detected by the photodetector 14 corresponding to a signal light subjected to orthogonal polarization multiplexing is noticeably higher than the optical power (substantially constant level) detected by the photodetector 14 corresponding to an ASE light. Accordingly, the presence or absence of a signal light subjected to orthogonal polarization multiplexing by the determination device 15 calculating the mean level of a signal output from the photodetector 14 and carrying out determination using a threshold, instead of monitoring a variation in the level of the output signal. The threshold may be set in a range between the level corresponding to an ASE light and the level corresponding to a signal light (S1+S2) illustrated in the graph of FIG. 14D. That is, when the mean level of a signal output from the photodetector 14 is at or above a preset threshold, the presence of a signal light may be determined, and when it is below the threshold, an interruption of a signal light may be determined.

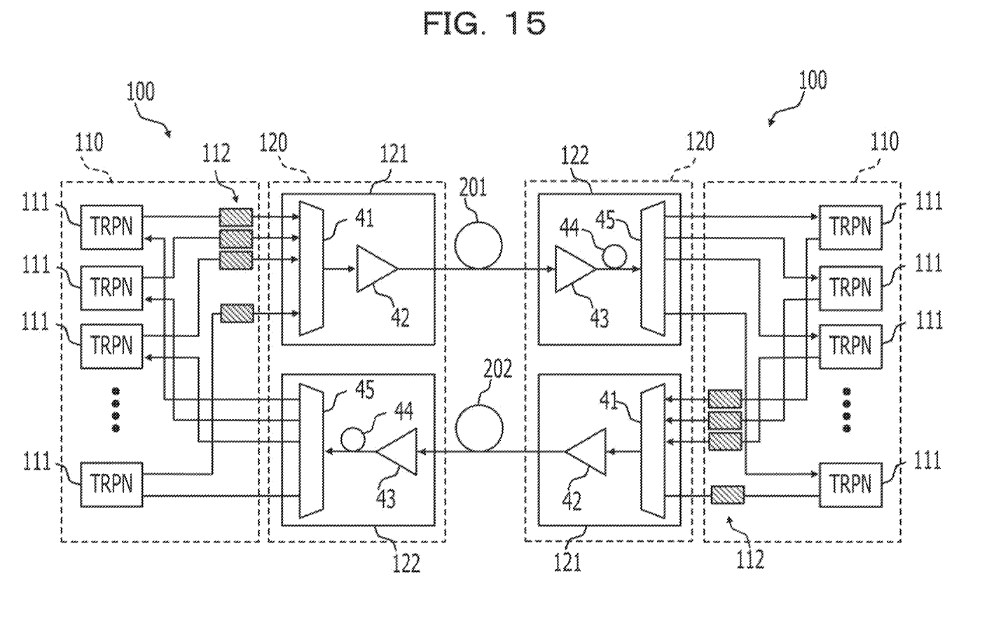

In relation to the above-described first and second embodiments, when a WDM optical transmission system as illustrated in, for example, FIG. 15, that is, a system that includes a polarization scrambler 112 inserted at a transmission end of each of the transponders is estimated, a signal light whose polarization state has been already scrambled is input to the optical receiver unit in each transponder. In this case, the function of rotating the polarization state achieved by the polarization rotator 12 in the first embodiment or by the rotary driver 16 in the second embodiment may be achieved by the polarization scrambler inserted at the transmission side of each of the transponders in the terminal apparatuses facing each other with the optical transmission lines 201 and 202 disposed therebetween. Accordingly, even if the polarization rotator 12 or the rotary driver 16 in the signal-light detection apparatus 10 is omitted, directly supplying a monitored light extracted by the splitter 11 to the polarization extractor 13 whose transmission axis is fixed and detecting the power of the transmitted light using the photodetector 14 enables the determination device 15 to determine the presence or absence of a signal light. A typical polarization rotation speed used in the polarization scrambler may be approximately several hundred kilohertz to one hundred megahertz. With such a rotation speed, a variation in the power of a polarization component extracted by the polarization extractor 13 may be sufficiently detected by the photodetector 14.

With the above-described signal-light detection apparatus and method, the presence or absence of a signal component included in the input light may be detected utilizing a difference between the polarization state of an ASE light occurring in an optical amplifier and that of a signal light by the use of a simple configuration that changes a relative angle between the direction of polarization of an input light and the axial direction of a polarization extractor, extracts a specified polarization component from the input light, and detects the power may detect.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A signal-light detection apparatus comprising:
a polarization extractor that extracts, from an input light, a polarization component that is substantially in parallel with a specified axial direction;
a polarization rotator that changes a relative angle between a direction of polarization of the input light and an axial direction of the polarization extractor;
a photodetector that detects an optical power of the polarization component extracted by the polarization extractor; and
a determination device that determines whether the input light includes a signal component, based on a variation in the optical power detected by the photodetector.

2. The signal-light detection apparatus according to claim 1, wherein the photodetector converts the polarization component extracted by the polarization extractor into an electric signal and outputs the electric signal to the determination device, and
the determination device determines that the input light includes the signal component when a level of an output signal output from the photodetector varies within a preset measurement time and determines that the input light does not include the signal component when the level of the output signal is substantially constant.

3. The signal-light detection apparatus according to claim 1, wherein the polarization rotator changes the relative angle in a range from 0° to at or above approximately 90°.

4. The signal-light detection apparatus according to claim 1, wherein
the axial direction of the polarization extractor is fixed, and
the polarization rotator includes a polarization rotator that rotates the direction of polarization of the input light.

5. The signal-light detection apparatus according to claim 4, wherein the polarization rotator comprises any one of a polarization controller, a Faraday rotator, liquid crystal, a polarization scrambler, a polarization modulator, a wave plate, a birefringent plate, and a polarization-maintaining fiber.

6. The signal-light detection apparatus according to claim 4, wherein, when a polarization scrambler is disposed at a signal-light transmission side, the polarization scrambler functions as the polarization rotator.

7. The signal-light detection apparatus according to claim 1, wherein the polarization rotator includes a rotary driver that changes the axial direction of the polarization extractor with respect to the direction of polarization of the input light by driving the polarization extractor to rotate.

8. The signal-light detection apparatus according to claim 1, wherein the polarization extractor comprises a polarizer or a polarization splitter.

9. The signal-light detection apparatus according to claim 1, wherein the determination device raises a loss of signal alarm when determining that the input light does not include the signal component.

10. The signal-light detection apparatus according to claim 1, wherein the determination device outputs a signal that indicates the determination whether the input light includes the signal component to enable shutdown control for an optical amplifier.

11. The signal-light detection apparatus according to claim 1, wherein, when a signal light subjected to polarization multiplexing is input, the determination device determines that the input light includes the signal component when a mean level of the power detected by the photodetector is at or above a preset threshold and determines that the input light does not include the signal component when the mean value is below the threshold.

12. A signal-light detection method comprising:
changing a relative angle between a direction of polarization of an input light and an axial direction of an element that extracts a specified polarization component from the input light;
extracting the specified polarization component from the input light using the element;
detecting optical power of the extracted polarization component; and
determining whether the input light includes the signal component, based on a change of the detected optical power.
